(19) United States
(12) Patent Application Publication
(10) Pub. No.: US 2023/0070175 A1
(43) Pub. Date: Mar. 9, 2023

(54) DUAL-POLARIZED MAGNETO-ELECTRIC DIPOLE WITH SIMULTANEOUS DUAL-BAND OPERATION CAPABILITY

(71) Applicant: Mobix Labs, Inc., Irvine, CA (US)

(72) Inventor: Meysam Moallem, Irvine, CA (US)

(21) Appl. No.: 17/930,650

(22) Filed: Sep. 8, 2022

Related U.S. Application Data
(60) Provisional application No. 63/242,372, filed on Sep. 9, 2021.

(51) Int. Cl. H01Q 21/26; H01Q 9/04; H01Q 9/16; H01Q 1/24

(52) U.S. Cl. CPC H01Q 21/26; H01Q 9/0407; H01Q 9/16; H01Q 1/241

(57) ABSTRACT

A dual-polarized, dual band antenna has first-band horizontal patches that are on a first layer with pairs of the first horizontal patches defining first electric dipoles for a first operating band. At least each subset of first-band vias are connected to a given one of the first-band horizontal patches and to the antenna ground layer to define first magnetic dipoles for the first operating band. First-band probes excite first magneto-electric dipoles. Second-band horizontal patches may be on a third layer with pairs of the second-band horizontal patches defining second electrical dipoles for a second operating band. At least each subset of the second-band vias are connected to a given one of the second-band horizontal patches and to the antenna ground layer to define second magnetic dipoles for the second operating band. Second-band probes excite the second magneto-electric dipoles as defined by the second electric dipoles and the second magnetic dipoles.

### CROSS-REFERENCE TO RELATED APPLICATIONS

This application relates to and claims the benefit of U.S. Provisional Application No. 63/242,372 filed Sep. 9, 2021 and entitled “DUAL-POLARIZED MAGNETO-ELECTRIC DIPOLE WITH SIMULTANEOUS DUAL-BAND OPERATION CAPABILITY,” the entire disclosure of which is wholly incorporated by reference herein.

### STATEMENT RE: FEDERALLY SPONSORED RESEARCH/DEVELOPMENT

Not Applicable

### BACKGROUND

### 1. Technical Field

The present disclosure relates generally to radio frequency (RF) devices, and more particularly, to antennas for millimeter wave phased array modules.

### 2. Related Art

Wireless communications systems find applications in numerous contexts involving information transfer over long and short distances alike, and a wide range of modalities tailored for each need have been developed. Generally, wireless communications utilize a radio frequency carrier signal that is modulated to represent data, and the modulation, transmission, receipt, and demodulation of the signal conform to a set of standards for coordination of the same. Many different mobile communication technologies or air interfaces exist, including GSM (Global System for Mobile Communications), EDGE (Enhanced Data rates for GSM Evolution), and UMTS (Universal Mobile Telecommunications System).

Various generations of these technologies exist and are deployed in phases, the latest being the 5G broadband cellular network system. 5G is characterized by significant improvements in data transfer speeds resulting from greater bandwidth that is possible because of higher operating frequencies compared to 4G and earlier standards. The air interfaces for 5G networks are comprised of two frequency bands, frequency range 1 (FR1), the operating frequency of which being below 6 GHz with a maximum channel bandwidth of 100 MHz, and frequency range 2 (FR2), the operating frequency of which being above 24 GHz with a channel bandwidth between 50 MHz and 400 MHz. The latter is commonly referred to as millimeter wave (mmWave) frequency range. Although the higher operating frequency bands, and mmWave/FR2 in particular, offer the highest data transfer speeds, the transmission distance of such signals may be limited. Furthermore, signals at this frequency range may be unable to penetrate solid obstacles and be subject to air propagation loss and oxygen absorption. To overcome these limitations while accommodating more connected devices, various improvements in cell site and mobile device architectures have been developed.

One such improvement is the use of multiple antennas at both the transmission and reception ends, also referred to as MIMO (multiple input, multiple output), which is understood to increase capacity density and throughput. A series of antennas may be arranged in a single or multi-dimensional array, and further, may be employed for beamforming where radio frequency signals are shaped to point in a specified direction of the receiving device. A single transmitter circuit can feed the signal to each of the antennas individually through splitters, with the phase of the signal as radiated from each of the antennas being varied over the span of the array. There are variations in which multiple transmitter circuits that can feed each antenna or a group of antennas. The collective signal radiated from the individual antennas may have a narrower beam width, and the direction of the transmitted beam may be adjusted based upon the constructive and destructive interferences of the signals radiated from each antenna resulting from the phase shifts. Beamforming may be used in both transmission and reception, and the spatial reception sensitivity may likewise be adjusted.

Within the FR2/millimeter wave frequency range of the 5G mobile network standard, there are further discrete frequency bands with defined bandwidths. The n257 band spans the 26.5 GHz to 29.5 GHz frequency range, the n258 band extends from 24.25 GHz to 27.50 GHz, the n259 band extends from 39.50 GHz to 43.50 GHz, the n260 band extends from 37.00 GHz to 40.00 GHz, the n261 band extends from 27.50 GHz to 28.35 GHz, and the n262 band extends from 47.20 GHz to 48.20 GHz. In order to maximize data throughput, there is a need for service providers to transmit and receive at both high band and low band simultaneously, and so antennas capable of such functionality are needed.

Further improvements in interference reduction and capacity increases are possible with antennas having multiple polarizations, including vertical/horizontal polarizations, circular polarization, and elliptical polarization that correspond to the physical orientation of the radio frequency waves radiating therefrom. Conventional 5G millimeter wave beamformer systems employ antennas with vertical polarization and horizontal polarization, and so it would be desirable for the multi-frequency transmit/receive antennas to handle both vertical and horizontal polarizations concurrently.

### BRIEF SUMMARY

One embodiment of the present disclosure is a dual-polarized, dual band antenna. The antenna may include an antenna ground layer, a set of first-band horizontal patches, a set of first-band vias, and first-band probes. The set of first-band horizontal patches may be on a first layer with pairs of the first horizontal patches defining first electric dipoles for a first operating band. At least each subset of the first-band vias may be connected to a given one of the first-band horizontal patches and to the antenna ground layer to define first magnetic dipoles for the first operating band. The first-band probes may excite first magneto-electric dipoles as defined by the first electric dipoles and the first magnetic dipoles, at least one part of one of the first-band probes being on a second layer. The antenna may include a set of second-band horizontal patches a set of second-band vias, and second-band probes. The second-band horizontal patches may be on a third layer with pairs of the second-band horizontal patches defining second electrical dipoles for a second operating band. At least each subset of the second-band vias may be connected to a given one of the second-band horizontal patches and to the antenna ground layer to define second magnetic dipoles for the second operating band. The second-band probes may excite the second magneto-electric dipoles as defined by the second electric dipoles and the second magnetic dipoles.

Yet another embodiment of the present disclosure may be a dual-polarized, dual band antenna having a multi-layer laminate structure. The antenna may have an antenna ground layer, along with first-band horizontal patches and a plurality of first-band probes. The first-band horizontal patches may be on one layer with first-band vias connecting the first-band horizontal patches to the antenna ground layer. The first-band probes may excite the first-band magneto-electric dipole defined by the first-band horizontal patches and the first-band vias. The antenna may also include second-band horizontal patches on another layer with second-band vias connecting the second-band horizontal patches to the antenna ground layer. There may be a plurality of second-band probes exciting a second-band magneto-electric dipole defined by the second-band horizontal patches and the second-band vias. The first-band horizontal patches may be in an at least partially overlapping relationship to the second-band horizontal patches.

Still another embodiment of the present disclosure is directed to a radio frequency transmit-receive module. There may be a beamformer integrated circuit with a first operating band and a second operating band, along with a multi-layer laminate structure antenna. This antenna may include an antenna ground layer, first-band horizontal patches, and a plurality of first-band probes. The first-band horizontal patches may be on one layer with first-band vias connecting the first-band horizontal patches to the antenna ground layer. The first-band probes may be connected to first operating band feedlines to the beamformer integrated circuit and exciting first-band magneto-electric dipoles defined by the first-band horizontal patches and the first-band vias. The antenna may also include second-band horizontal patches on another layer with second-band vias connecting the second-band horizontal patches to the antenna ground layer. There may also be a plurality of second-band probes that are connected to second operating band feedlines to the beamformer integrated circuit and exciting second-band magneto-electric dipoles defined by the second-band horizontal patches and the second-band vias. The first-band horizontal patches may be in an at least partially overlapping relationship with the second-band horizontal patches.

The present disclosure will be best understood accompanying by reference to the following detailed description when read in conjunction with the drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a dual band, dual-polarized, magneto-electric dipole antenna according to another embodiment of the present disclosure;

FIG. 2 is a side view of the dual band, dual-polarized, magneto-electric dipole antenna;

FIG. 3 is a perspective view of the low/first-band magneto-electric dipoles of the dual-polarized, dual-band antenna;

FIG. 4 is a perspective view of the low/first-band probes exciting the low/first-band dipoles of the dual-polarized, dual-band antenna;

FIG. 5 is a perspective view of the high/second-band magneto-electric dipoles of the dual-polarized, dual-band antenna;

FIG. 6 is a perspective view of the high/second-band probes exciting the high/second-band dipoles of the dual-polarized, dual-band antenna;

FIG. 7 is a simulated antenna radiation plot of the high/second-band magneto-electric dipole;

FIG. 8 is a simulated antenna radiation plot of the low/first-band magneto-electric dipole;

FIG. 9 is a graph plotting the simulated input return loss for each of the magneto-electric dipole elements;

### DETAILED DESCRIPTION

The present disclosure is directed to various embodiments of antenna elements configured for millimeter wave operating frequency bands in the Kₐ and V portions of the spectrum. Some embodiments may be utilized in next generation 5G beamformer applications, which may have a designated operating frequency bands as mentioned previously. According to one contemplated embodiment, the term high band (HB) may be used to refer to those operating frequencies between 37 GHz to 43.5 GHz, while the term low band (LB) may be used to refer to those operating frequencies between 24.25 to 29.5 GHz. Relative to the published 5G mmWave bands, LB may correspond to portions of the n257 band, the n258 band, and the n261 band, while HB may correspond to portions of the n259 band and the n260 band. The antenna is contemplated to transmit and receive HB and LB signals simultaneously or one at a time, with both horizontal polarization and vertical polarization. Generally, the embodiments of the antenna elements are envisioned to allow transmit/receive operation with any combination of the four feeds to the antenna at each time such as LB-vertical polarization and HB-horizontal polarization at one time, or LB-vertical polarization, HB-vertical polarization, and HB-horizontal polarization at another time, and so on.

The embodiments of the present disclosure will be described in the context of the 5G mmWave operating environment and the aforementioned frequency bands, though it will be appreciated by those having ordinary skill in the art that the antenna may be adopted to other operating environments, particularly with other microwave systems possibly having different frequency bands. Suitable modifications to the antenna array and antenna element structures for adaptation to such alternative operating environments are deemed to be within the purview of the present disclosure, with reference to specific operating frequency bands corresponding to other frequency bands/ranges.

he detailed description set forth below in connection with the appended drawings is intended as a description of the several presently contemplated embodiments of the antennas and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second, proximal and distal, left and right, top and bottom, upper and lower, and the like are used solely to distinguish one from another entity without necessarily requiring or implying any actual such relationship or order between such entities.

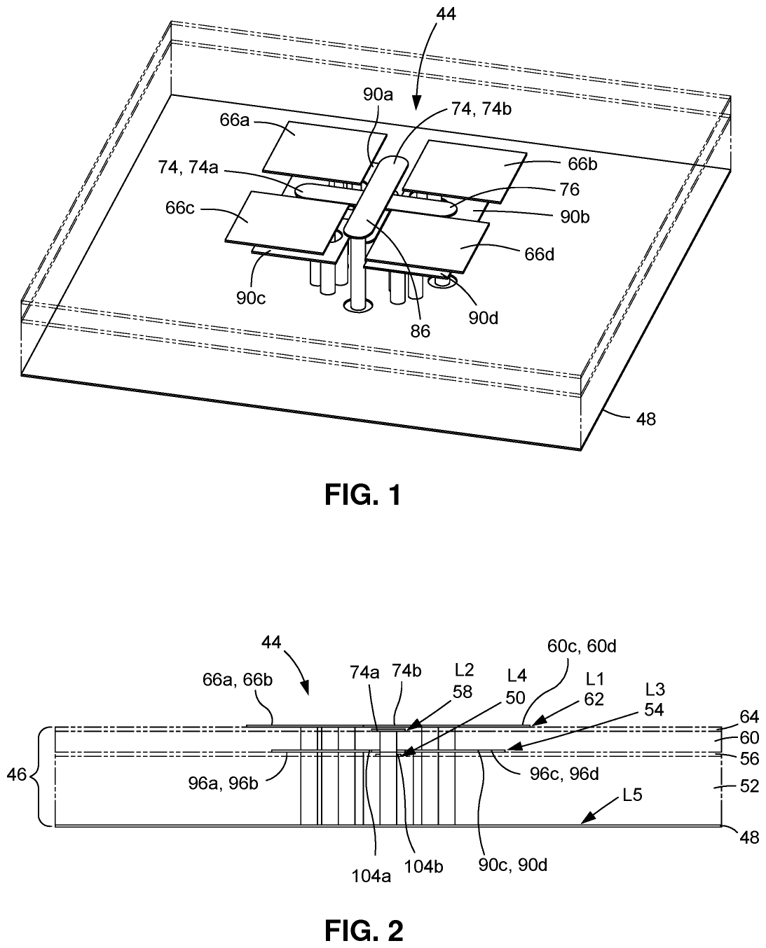

With reference to FIGS. 1 and 2, a dual-polarized magneto-electric dipole antenna 44 is implemented as a multi-layer laminate structure 46 using conventional laminate manufacturing processes. In further detail, the dual-polarized magneto-electric dipole antenna 44 includes an antenna ground layer 48, also referred to as layer L5. The antenna ground layer 48 is understood to be a ground plane, and thus it is a metal/conductive layer. This embodiment of the dual-polarized magneto-electric dipole antenna 44 may be implemented over a total of five metal layers, with substrate layers in between. Specifically, above metal layer L5 is metal layer 50, also referred to as L4. Between L5 and L4 there may be a substrate layer 52. Above the L4 metal layer 50 is metal layer 54, also referred to as L3, with a substrate layer 56 in between. Next, above L3 metal layer 54 is a metal layer 58 referred to as L2, with a substrate layer 60 in between. Lastly, above L2 metal layer 58 is a metal layer 62 also referred to as L1, with a substrate layer 64 in between. The substrate layers 52, 56, 60, and 64 may be a dielectric material, or air. Different parts of the dual-polarized magneto-electric dipole antenna 44 are implemented on different metal layers, as will be described in further detail below.

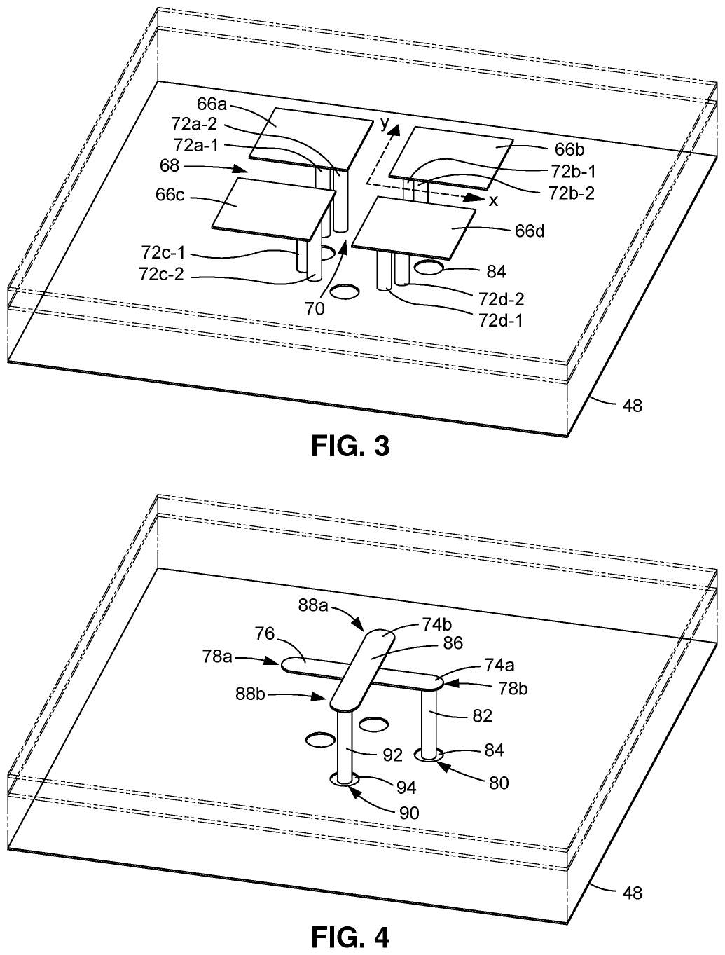

With additional reference to FIG. 3, the dual-polarized magneto-electric dipole antenna 44 includes a set of first-band horizontal patches 66, including a first first-band horizontal patch 66a, a second first-band horizontal patch 66b, a third first-band horizontal patch 66c, and a fourth first-band horizontal patch 66d. The first-band horizontal patches 66 are implemented on the L1 metal layer 62. Each of the first-band horizontal patches 66 are understood to have the same rectangular shape and of equal size and positioned to be equidistant from other adjacent patches in both the vertical and horizontal direction. In other words, the y-axis separation between the first first-band horizontal patch 66a and the third first-band horizontal patch 66c, and the x-axis separation between the first first-band horizontal patch 66a and the second first-band horizontal patch 66b is the same. Likewise, the x-axis separation between the third first-band horizontal patch 66c and the fourth first-band horizontal patch 66d is the same as the y-axis separation between the second first-band horizontal patch 66b and the fourth first-band horizontal patch 66d.

As between the first first-band horizontal patch 66a and the third first-band horizontal patch 66c, as well as between the second first-band horizontal patch 66b and the fourth first-band horizontal patch 66d, there may be defined an x-axis or horizontal aperture 68. The first first-band horizontal patch 66a and the third first-band horizontal patch 66c may be referred to as a first subset pair, while the second first-band horizontal patch 66b and the fourth first-band horizontal patch 66d may be referred to as a second subset pair. As between the first first-band horizontal patch 66a and the second first-band horizontal patch 66b (referred to as a third subset pair), as well as between the third first-band horizontal patch 66c and the fourth first-band horizontal patch 66d (referred to as a fourth subset pair) there may be defined a y-axis or vertical aperture 70. The terms horizontal and vertical with respect to the apertures is understood to be specific to the perspective of the L1 metal layer plane as viewed in FIG. 3. As such, the only relevance of such terms is to distinguish one direction from another, not that the space identified as the vertical aperture 70 or horizontal aperture 68 is vertical or horizontal, respectively, in all cases and orientations.

Each of the first-band horizontal patches 66 are shorted/electrically connected to the antenna ground layer 48 over first-band vias 72. In the illustrated embodiment, connected to the first first-band horizontal patch 66a are the first-band vias 72a-1 and 72a-2 that are positioned at the bottom left corner thereof. First-band vias 72b-1 and 72b-2 are connected to the second first-band horizontal patch 66b and positioned at the bottom right corner thereof. First-band vias 72c-1 and 72c-2 are connected to the third first-band horizontal patch 66c and positioned at the top left corner thereof. Lastly, first-band vias 72d-1 and 72d-2 are connected to the fourth first-band horizontal patch 66d and positioned at the top right corner thereof. Each of the first-band vias 72 extend from the L1 metal layer 62 to the L5 antenna ground layer 48. Although the illustrated example shows two vias for each horizontal patch 66, this is by way of example only. There may be a single via for each horizontal patch 66, or there may be more than two vias for each horizontal patch 66.

The dimensions of the first-band horizontal patches 66 along with the dimensions of the first-band vias 72 (e.g., their height) connected thereto are understood to be optimized to achieve the best/minimum input return loss in the LB operating frequency band. However, it will be appreciated that these and other dimensions of the structure are tuned or optimized for the best overall performance, as some of the low band operating parameters such as return loss, gain, and so forth, may be influenced or affected by components that are associated with high band operation.

The horizontal patches and their corresponding vias are understood to define the magneto-electric dipoles. More particularly, different pairs of the first-band horizontal patches 66 define the electric dipoles for the horizontal and vertical polarizations. A pair defined by the first first-band horizontal patch 66a and the second first-band horizontal patch 66b, as well as a pair defined by the third first-band horizontal patch 66c and the fourth first-band horizontal patch 66d may be part of the horizontal polarization electric dipole. The magnetic dipole may be defined by the corresponding first-band vias 72. The first-band vias 72a-1 and 72a-2 connected to the first first-band horizontal patch 66a, as well as the first-band vias 72b-1 and 72b-2 connected to the second first-band horizontal patch 66b may define the magnetic dipole for the corresponding horizontal polarization electric dipole of such horizontal patch pair. Similarly, the first-band vias 72c-1 and 72c-2 connected to the third first-band horizontal patch 66c as well as the first-band vias 72d-1 and 72d-2 connected to the fourth first-band horizontal patch 66d may also define the magnetic dipole for the corresponding horizontal polarization electric dipole of such horizontal patch pair.

A pair defined by the first first-band horizontal patch 66a and the third first-band horizontal patch 66c, and another pair defined by the second first-band horizontal patch 66b and the fourth first-band horizontal patch 66d may be part of the vertical polarization electric dipole. Again, the magnetic dipole may be defined by the corresponding first-band vias 72. The first-band vias 72a-1 and 72a-2 connected to the first first-band horizontal patch 66a, as well as the first-band vias 72c-1 and 72c-2 connected to the third first-band horizontal patch 66c may define the magnetic dipole for the corresponding vertical polarization electric dipole of such horizontal patch pair. The first-band vias 72b-1 and 72b-2 connected to the second first-band horizontal patch 66b as well as the first-band vias 72d-1 and 72d-2 connected to the fourth first-band horizontal patch 66d may define the magnetic dipole for the corresponding vertical polarization electric dipole of such horizontal patch pair.

Referring now to FIGS. 1, 2, and 4, the first-band horizontal patches 66, and specifically the magneto-electric dipoles defined thereby, are excited by first-band probes 74. According to the illustrated embodiment, there may be a horizontal first-band probe 74a that excites the horizontal-polarization magneto-electric dipoles, as well as a vertical first-band probe 74b that excites the vertical-polarization magneto-electric dipoles.

As shown in FIG. 4, the horizontal first-band probe 74a is defined by an elongate, horizontally oriented strip 76 defined by a distal end 78a and a proximal end 78b. The horizontally oriented strip 76 is implemented on the L2 metal layer 58 and is connected to a first-band horizontal polarization feed 80 with a first-band horizontal probe via 82 connected to the proximal end 78b. The first-band horizontal polarization feed 80 may be positioned underneath the L5 antenna ground layer 48, so it may define an opening 84 through which the first-band horizontal probe via 82 extends.

The vertical first-band probe 74b is similarly defined by an elongate, though vertically oriented strip 86 defined by a distal end 88a and a proximal end 88b. The vertically oriented strip 86 is implemented on the L1 metal layer 62 and thus above the horizontally oriented strip 76. The vertically oriented strip 86 is connected to a first-band vertical polarization feed 90 over a first-band vertical probe via 92 at the proximal end 88b. The L5 antenna ground layer 48 is understood to define another opening 94 for the first-band vertical probe via 92 to pass through in order to reach the first-band vertical polarization feed 90.

Because the first-band probes 74 are defined by a horizontal strip portion and a vertical via portion, they may also be referred to as F (gamma)-shaped probes. FIG. 1 illustrates the positioning of the first-band probes 74 within the horizontal aperture 68 and the vertical aperture 70. The center of the horizontally oriented strip 76, and hence the horizontal first-band probe 74a, is positioned centrally with respect to the first-band horizontal patches 66, e.g., at the intersection between the horizontal aperture 68 and the vertical aperture 70. Similarly, the center of the vertically oriented strip 86 and the vertical first-band probe 74b is positioned centrally relative to the first-band horizontal patches 66. The first-band probes 74 may thus be oriented perpendicularly to each other, with the horizontal first-band probe 74a being at least partially overlaid on the vertical first-band probe 74b at the intersection of such components.

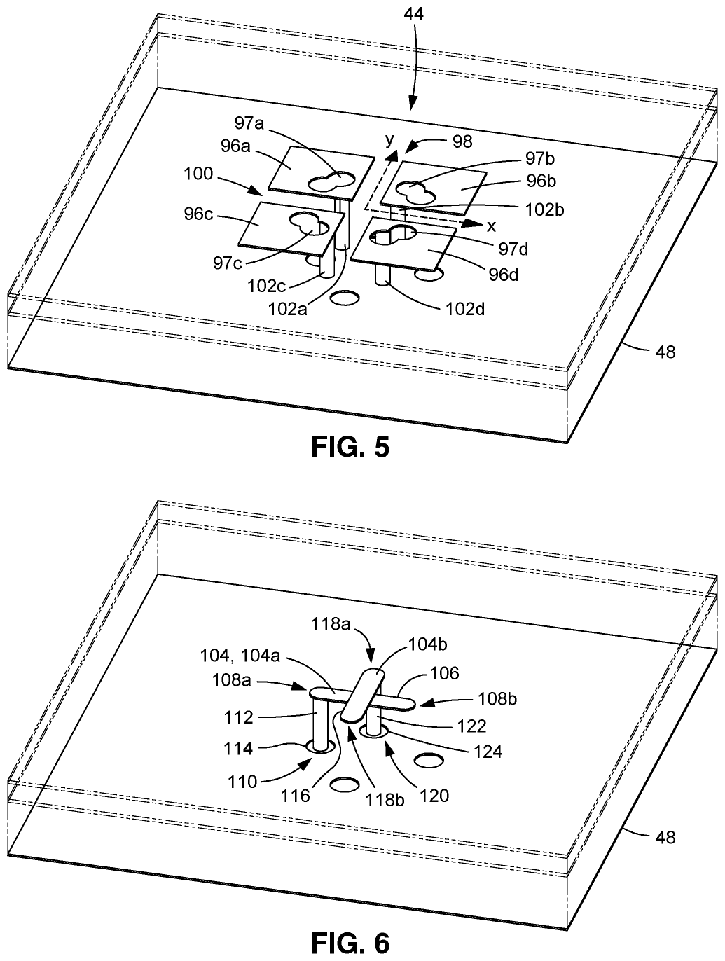

Referring back to FIG. 1, the dual-polarized magneto-electric dipole antenna 44 also includes a set of second-band horizontal patches 96. This includes a first second-band horizontal patch 96a, a second second-band horizontal patch 96b, a third second-band horizontal patch 96c, and a fourth second-band horizontal patch 96d. As best illustrated in FIG. 5, the second-band horizontal patches 96 are arranged in a quadrangular pattern spaced apart from each other. Each of the horizontal patches have the same rectangular shape and are of equal size and positioned to be equidistant from other adjacent patches in both the vertical and horizontal direction. The y-axis separation between the first second-band horizontal patch 96a and the third second-band horizontal patch 96c, and the x-axis separation between the first second-band horizontal patch 96a and the second second-band horizontal patch 96b is the same. Likewise, the x-axis separation between the third second-band horizontal patch 96c and the fourth second-band horizontal patch 96d is the same as the y-axis separation between the second second-band horizontal patch 96b and the fourth second-band horizontal patch 96d.

The second-band horizontal patches 96 may be implemented on the L3 metal layer 54, which is underneath the L1 metal layer 62 on which the first-band horizontal patches 66 are implemented. Thus, the first-band horizontal patches 66 at least partially overlap the second-band horizontal patches 96. The planar separation between the first-band horizontal patches 66 is understood to be greater than the planar separation between the second-band horizontal patches 96. For example, the y-axis separation between the first first-band horizontal patch 66a and the third first-band horizontal patch 66c is greater than the y-axis separation between the first second-band horizontal patch 96a and the third second-band horizontal patch 96c. Similarly, the x-axis separation between the first first-band horizontal patch 66a and the second first-band horizontal patch 66b is understood to be greater than the x-axis separation between the first second-band horizontal patch 96a and the second second-band horizontal patch 96b. These specifics are presented for exemplary purposes only, and the embodiments of the present disclosure need not be limited thereto. For instance, the separation between the first-band horizontal patches 66 may be the same or less than the separation between the second-band horizontal patches 96.

Because the first-band horizontal patches 66 overlap the second-band horizontal patches 96, particularly where the first-band vias 72 positionally coincide therewith, the second-band horizontal patches 96 each define an opening or via passageway 97. Thus, in the bottom left corner of the first second-band horizontal patch 96a there is a first passageway 97a, and in the bottom right corner of the second second-band horizontal patch 96b there is a second passageway 97b. Furthermore, in the top left corner of the third second-band horizontal patch 96c there is a third passageway 97c, and in the top left corner of the fourth second-band horizontal patch 96d there is a fourth passageway 97d. The passageways 97 may be shaped as two partially coincident arcuate openings with each corresponding to a given one of the first-band vias 72, or it may be two non-contiguous openings. The curvatures of the outlines of the passageways 97 are presented by way of example only and not of limitation, and any other shape or size of the passageways 87 may be substituted without departing from the scope of the present disclosure.

As between the first second-band horizontal patch 96a and the third second-band horizontal patch 96c, as well as between the second second-band horizontal patch 96b and the fourth second-band horizontal patch 96d, there may be defined an x-axis or horizontal aperture 100. The first second-band horizontal patch 96a and the third second-band horizontal patch 96c may be referred to as a first subset pair, while the second second-band horizontal patch 96b and the fourth second-band horizontal patch 96d may be referred to as a second subset pair. As between the first second-band horizontal patch 96a and the second second-band horizontal patch 96b (referred to as a third subset pair), as well as between the third second-band horizontal patch 96c and the fourth second-band horizontal patch 96d (referred to as a fourth subset pair) there may be defined a y-axis or vertical aperture 98. Again, the terms horizontal and vertical with respect to the apertures is understood to be specific to the perspective of the L3 metal layer plane as viewed in FIG. 5.

Each of the second-band horizontal patches 96 are shorted/electrically connected to the antenna ground layer 48 over second-band vias 102. In the illustrated embodiment shown in FIG. 5, connected to the first second-band horizontal patch 96a is a second-band via 102 that is positioned at the bottom left corner thereof. A second-band via 102b is connected to the second second-band horizontal patch 96b and positioned at the bottom right corner thereof. A second-band via 102c is connected to the third second-band horizontal patch 96c and positioned at the top left corner thereof. Lastly, a second-band via 102d is connected to the fourth second-band horizontal patch 96d and positioned at the top right corner thereof. Each of the second-band vias 102 extend from the L3 metal layer 54 to the L5 antenna ground layer 48. Although the example embodiment shows one second-band via 102 for each second-band horizontal patch 96, the antenna of the present disclosure need not be limited thereto. In other embodiments, there may be more than one second-band via 102 connecting the second-band horizontal patches 96 to the L5 antenna ground layer 58.

The dimensions of the second-band horizontal patches 96 along with the dimensions of the second-band vias 102 (e.g., their height) connected thereto are understood to be optimized to achieve the best/minimum input return loss in the HB operating frequency band. Again, as indicated above in the context of the components associated with the low band operation, these and other dimensions of the structure are tuned or optimized for the best overall performance. Some of the high band operating parameters such as return loss, gain, and so forth, may be influenced or affected by components that are associated with low band operation,

The horizontal patches and their corresponding vias are understood to define the magneto-electric dipole. Different pairs of the second-band horizontal patches 96 define the electric dipoles for the horizontal and vertical polarizations. A pair defined by the first second-band horizontal patch 96a and the second second-band horizontal patch 96b, as well as a pair defined by the third second-band horizontal patch 96c and the fourth second-band horizontal patch 96d may be part of the horizontal polarization electric dipole. The magnetic dipole may be defined by the corresponding second-band vias 102. The second-band via 102a connected to the first second-band horizontal patch 96a, as well as the second-band via 102b connected to the second second-band horizontal patch 96b may define the magnetic dipole for the corresponding horizontal polarization electric dipole of such horizontal patch pair. Similarly, the second-band via 102c connected to the third second-band horizontal patch 96c as well as the second-band via 102d connected to the fourth second-band horizontal patch 96d may also define the magnetic dipole for the corresponding horizontal polarization electric dipole of such horizontal patch pair.

A pair defined by the first second-band horizontal patch 96a and the third second-band horizontal patch 96c, and another pair defined by the second second-band horizontal patch 96b and the fourth second-band horizontal patch 96d may be part of the vertical polarization electric dipole. Again, the magnetic dipole may be defined by the corresponding second-band vias 102. The second-band via 102a connected to the first second-band horizontal patch 96a, and the second-band via 102c connected to the third second-band horizontal patch 96c may define the magnetic dipole for the corresponding vertical polarization electric dipole of such horizontal patch pair. The second-band via 102b connected to the second second-band horizontal patch 96b as well as the second-band via 102d connected to the fourth second-band horizontal patch 96d may define the magnetic dipole for the corresponding vertical polarization electric dipole of such horizontal patch pair.

Referring now to FIGS. 1, 5, and 6, the second-band horizontal patches 96, and specifically the magneto-electric dipoles defined thereby, are excited by second-band probes 104. According to the illustrated embodiment, there may be a horizontal second-band probe 104a that excites the horizontal-polarization magneto-electric dipoles, as well as a vertical second-band probe 104b that excites the vertical-polarization magneto-electric dipoles.

As shown in FIG. 6, the horizontal second-band probe 104a is defined by an elongate, horizontally oriented strip 106 defined by a proximal end 108a and a distal end 108b. The horizontally oriented strip 106 is implemented on the L4 metal layer 50 and is connected to a second-band horizontal polarization feed 110 with a second-band horizontal probe via 112 connected or attached to the proximal end 108a. The second-band horizontal polarization feed 110 may be located underneath the antenna ground layer 48/L5, so there may be defined an opening 114 through which the second-band horizontal probe via 112 extends.

The vertical second-band probe 104b is similarly defined by an elongate, though vertically oriented strip 116 defined by a proximal end 118a and a distal end 118b. The vertically oriented strip 116 is implemented on the L3 metal layer 54 and thus above the horizontally oriented strip 106. The vertically oriented strip 116 is connected to a second-band vertical polarization feed 120 over a second-band vertical probe via 122 at the proximal end 118a. The L5 antenna ground layer 48 is understood to define another opening 124 for the second-band vertical probe via 122 to pass through in order to reach the second-band vertical polarization feed 120.

Like the first-band probes discussed earlier, the second-band probes 104 are defined by a horizontal strip portion and a vertical via portion so they may also be referred to as F (gamma)-shaped probes. The second-band probes 104 are positioned within the horizontal aperture 100 and the vertical aperture 98. The center of the horizontally oriented strip 106, and hence the horizontal second-band probe 104a, is positioned centrally with respect to the second-band horizontal patches 96, e.g., at the intersection between the horizontal aperture 100 and the vertical aperture 98. Similarly, the center of the vertically oriented strip 116 and the vertical second-band probe 104b is positioned centrally relative to the second-band horizontal patches 96. The second-band probes 104 may be oriented perpendicularly to each other, with the vertical second-band probe 104b being at least partially overlaid on the horizontal second-band probe 104a at the intersection of such components.

Any given one of, or subsets of the first-band probes 74 or the second-band probes 104 may be selectively and simultaneously activated to excite the associated first-band or second band magneto-electric dipoles. For example, the horizontal first-band probe 74a, the vertical first-band probe 74b can be activated simultaneously to excite the first-band magneto-electric dipoles with a circular polarization, while activating only the one second-band probe 104a, for example, may effectuate a linear polarization for the signal transmitted from the second-band magneto-electric dipoles.

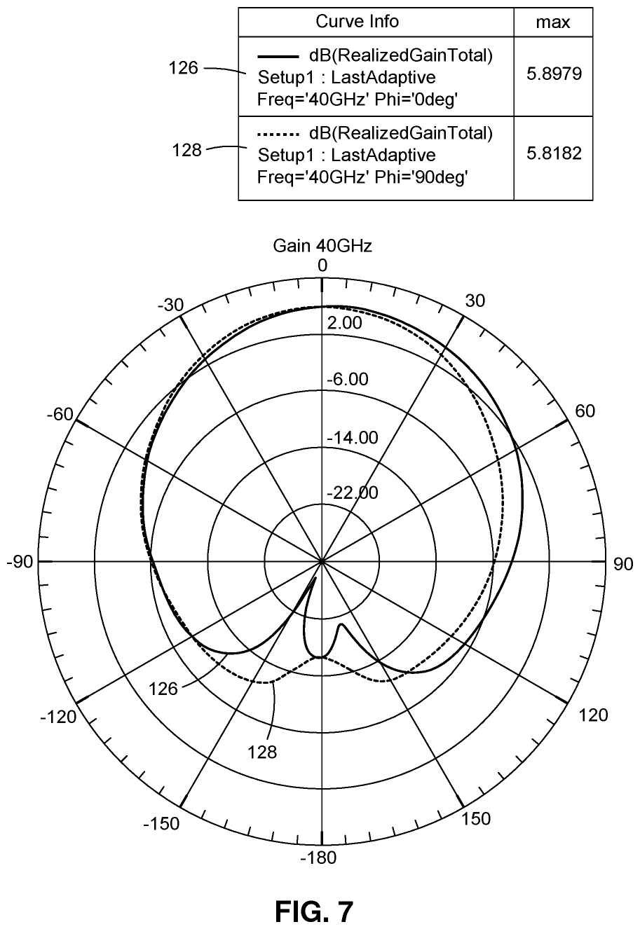

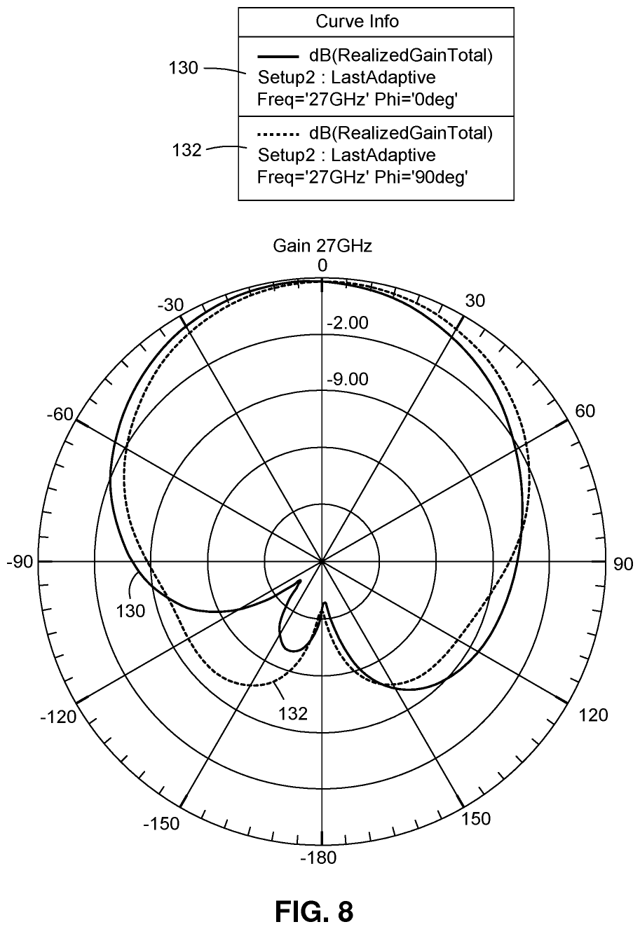

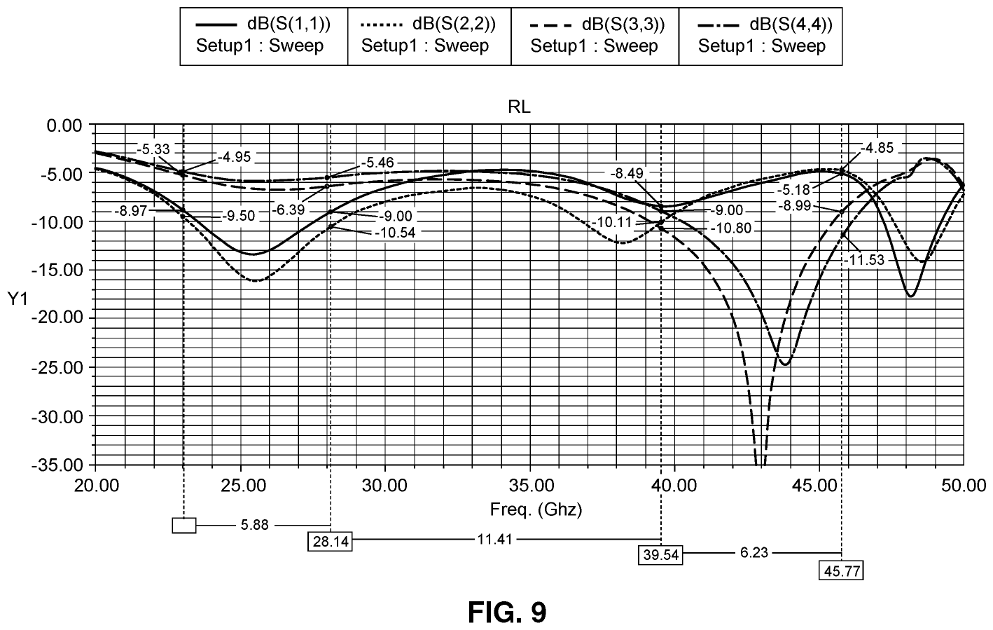

The antenna radiation plot of FIG. 7 illustrates the simulated performance of the dual-polarized magneto-electric dipole antenna 44 in high band operation at 40 GHz. More specifically, the first plot 126 shows the gain of the antenna over a 360-degree field in the azimuth plane (xy plane/φ=0°), while the second plot 128 shows the gain in the elevation plane (yz plane/φ=90°). The antenna radiation plot of FIG. 8 illustrates the simulated performance of the dual-polarized magneto-electric dipole antenna 44 at 27 GHz. Similarly, a first plot 130 shows the gain of the antenna in the azimuth plane and a second plot 132 shows the gain in the elevation plane. The graph of FIG. 9 shows the input return loss/reflection coefficient of the dual-polarized magneto-electric dipole antenna 44 at the first-band horizontal polarization feed 80 (S11), first-band vertical polarization feed 90 (S22), the second-band horizontal polarization feed 110 (S33), and the second-band vertical polarization feed 120 (S44). Moreover, the low band peak gain at 27 GHz is approximately 4.4 dBi, while the high band peak gain at 40 GHz is approximately 5.8 dBi.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. A dual-polarized, dual band antenna comprising:
an antenna ground layer;
a set of first-band horizontal patches on a first layer with pairs of the first horizontal patches defining first electric dipoles for a first operating band;
a set of first-band vias, at least each subset of which are connected to a given one of the first-band horizontal patches and to the antenna ground layer to define first magnetic dipoles for the first operating band;
first-band probes exciting first magneto-electric dipoles as defined by the first electric dipoles and the first magnetic dipoles, at least one part of one of the first-band probes being on a second layer;
a set of second-band horizontal patches on a third layer with pairs of the second-band horizontal patches defining second electrical dipoles for a second operating band;
a set of second-band vias, at least each subset of which are connected to a given one of the second-band horizontal patches and to the antenna ground layer to define second magnetic dipoles for the second operating band; and
second-band probes exciting the second magneto-electric dipoles as defined by the second electric dipoles and the second magnetic dipoles.

2. The antenna of claim 1, wherein the first operating band is a 5G millimeter wave low band operating frequency range between 24.25 GHz to 29.5 GHz and the second operating band is a 5G millimeter wave high band operating frequency range between 37 GHz to 43.5 GHz.

3. The antenna of claim 1, wherein each of the second-band horizontal patches are overlapped by a corresponding one of the first-band horizontal patches and further defining an opening through which a corresponding subset of the first vias passes.

4. The antenna of claim 1, wherein the first-band horizontal patches, the first-band vias, the first-band probes, the second-band horizontal patches, the second-band vias, and the second-band probes are implemented as a multi-layer laminate structure.

5. The antenna of claim 1, wherein the first-band probes and the second-band probes are gamma-shaped.

6. The antenna of claim 5, wherein a first one of the first-band probes includes a first-band vertical direction strip on the first layer and a first first-band probe via connected to the vertical direction strip and the antenna ground layer, a second one of the first-band probes including a first-band horizontal direction strip on the second layer and a second first-band probe via connected to the first-band horizontal direction strip and the antenna ground layer.

7. The antenna of claim 6, wherein the first-band horizontal patches are spaced apart from each other in a quadrangular arrangement and defining an x-axis aperture extending between a first subset pair of first-band horizontal patches and a second subset pair of first-band horizontal patches, and a y-axis aperture between a third subset pair of first-band horizontal patches and a fourth subset pair of first-band horizontal patches.

8. The antenna of claim 7, wherein the first-band horizontal direction strip is positioned within the x-axis open space and the first-band vertical direction strip is positioned within the y-axis open space.

9. The antenna of claim 5, wherein a first one of the second-band probes includes a second-band vertical direction strip on the third layer and a first second-band probe via connected to the second-band vertical direction strip and the antenna ground layer, a second one of the second-band probes including a second-band horizontal direction strip on a fourth layer and a second second-band probe via connected to the second-band horizontal direction strip and the antenna ground layer.

10. The antenna of claim 6, wherein the second-band horizontal patches are spaced apart from each other in a quadrangular arrangement and defining an x-axis aperture extending between a first subset pair of second-band horizontal patches and a second subset pair of second-band horizontal patches, and a y-axis aperture between a third subset pair of second-band horizontal patches and a fourth subset pair of second-band horizontal patches.

11. The antenna of claim 10, wherein the second-band horizontal direction strip is positioned within the x-axis aperture and the second-band vertical direction strip is positioned within the y-axis aperture.

12. A dual-polarized, dual band antenna having a multi-layer laminate structure, comprising:
an antenna ground layer;
first-band horizontal patches on one layer with first-band vias connecting the first-band horizontal patches to the antenna ground layer;
a plurality of first-band probes exciting a first-band magneto-electric dipole defined by the first-band horizontal patches and the first-band vias;
second-band horizontal patches on another layer with second-band vias connecting the second-band horizontal patches to the antenna ground layer; and
a plurality of second-band probes exciting a second-band magneto-electric dipole defined by the second-band horizontal patches and the second-band vias;
wherein the first-band horizontal patches are in an at least partially overlapping relationship to the second-band horizontal patches.

13. The antenna of claim 12, wherein first pairs of first-band horizontal patches and corresponding first-band vias define a magneto-electric dipole for a first operating band horizontal polarization, and second pairs of first-band horizontal patches and corresponding first-band vias define a magneto-electric dipole for a first operating band vertical polarization.

14. The antenna of claim 13, wherein the first operating band is a 5G millimeter wave low band operating frequency range between 24.25 GHz to 29.5 GHz.

15. The antenna of claim 12 wherein first pairs of second-band horizontal patches and corresponding second-band vias define a magneto-electric dipole for a second operating band horizontal polarization, and second pairs of second-band horizontal patches and corresponding second-band vias define a magneto-electric dipole for a second operating band vertical polarization.

16. The antenna of claim 15, wherein the second operating band is a 5G millimeter wave high band operating frequency range between 37 GHz to 43.5 GHz.

17. The antenna of claim 12, wherein the second-band horizontal patches define openings through which the first-band vias between the first-band horizontal patches and the antenna ground layer passes.

18. The antenna of claim 12, wherein the first-band probes and the second-band probes are gamma-shaped.

19. The antenna of claim 12, wherein:
one of the first-band probes is a first-band horizontal polarization excitation source, another one of the first-band probes is a first-band vertical polarization excitation source, one of the second-band probes is a second-band horizontal polarization excitation source, and another one of the second-band probes is a second-band vertical polarization excitation source;
the first-band horizontal polarization excitation source, the first-band vertical polarization excitation source, the second-band horizontal polarization excitation source, and the second-band vertical polarization excitation source are selectively activated either individually or in different combinations.

20. A radio frequency transmit-receive module comprising:
a beamformer integrated circuit with a first operating band and a second operating band; and
a multi-layer laminate structure array of multiple antenna elements, each antenna including:
an antenna ground layer;
first-band horizontal patches on one layer with first-band vias connecting the first-band horizontal patches to the antenna ground layer;
a plurality of first-band probes connected to a first operating band feedline to the beamformer integrated circuit and exciting a first-band magneto-electric dipole defined by the first-band horizontal patches and the first-band vias;
second-band horizontal patches on another layer with second-band vias connecting the second-band horizontal patches to the antenna ground layer; and
a plurality of second-band probes connected to a second operating band feedline to the beamformer integrated circuit and exciting a second-band magneto-electric dipole defined by the second-band horizontal patches and the second-band vias;
wherein the first-band horizontal patches are in an at least partially overlapping relationship with the second-band horizontal patches.
